(19) United States
(12) Patent Application Publication
(10) Pub. No.: US 2024/0140761 A1
(43) Pub. Date: May 2, 2024

(54) A NOVEL LOAD TRANSPORTATION SYSTEM

(71) Applicant: ASHIR VAISH, New Delhi (IN)

(72) Inventor: ASHIR VAISH, New Delhi (IN)

(21) Appl. No.: 18/269,739

(22) PCT Filed: Oct. 7, 2021
(86) PCT No.: PCT/IN2021/050966

§ 371 Date: Jun. 26, 2023

(30) Foreign Application Priority Data
Dec. 28, 2020 (IN) 202011056619

(51) Int. Cl. B66C 9/04

(52) U.S. Cl. CPC B66C 9/04

(57) ABSTRACT

Overhead transportation system allows multiple transportation vehicles to transport individual loads simultaneously in X-Y-Z guided path. Plurality of overhead cranes supported by a transport vehicle, a guided rail matrix on each level, a lift mechanism at one or more ends of the guided rail matrix, and a control system allows said overhead cranes supported by transport vehicles mounted over the guide rail matrix to travel in X-Y-Z direction for material handling and storage. The guide rail matrix comprises a plurality of cells formed and the transport vehicle runs on guide rails surrounding the cells. Controllers are not limited to programmable logic controllers, microcontrollers etc. In another embodiment, a plurality of overhead crane are integrated with a microcontroller and sensing unit to avoid collision between vehicles and material carried. Optional robotic arms or portable machinery to place material appropriately or perform work (packing, machining, other operations) to produce goods.

### TECHNICAL FIELD OF THE INVENTION

The present invention relates to the field of overhead crane systems for use in material handling, transportation and storage processes. Broadly, the invention relates to the field of transporting any item from one point to another across a three-dimensional lattice or space. More particularly, the present invention relates to an efficient overhead system used in material handling, transportation and storage processes that allows a plurality of overhead cranes to travel and transport load across three dimensions on a guided path and to carry out transport operations.

### BACKGROUND OF THE INVENTION

In a manufacturing unit to develop a final product, the material undergoes several processes such as machining, extrusion, polishing and many more. To accommodate all the manufacturing processes, there are variety of sites in the manufacturing unit. Based on the product, the material is taken from one site to another to carry out the specific manufacturing process. Hence, taking material from one site to another is an as important task for the pace of production as any other manufacturing process.

Conventionally, the manufacturing units use a lot of material handling equipment such as lift trucks, narrow aisle lift trucks, conveyors, cranes, industrial robots and many more. Most of these material handling equipment run on ground only and carry material from one place to another. Since, both material handling equipment and the human workforce are working on the same ground, hence there becomes a requirement of make bigger manufacturing units to accommodate both. Bigger manufacturing units have several drawbacks such as cost, industrial compliances, and constant fear of accidents due to sharing same space between manpower and handling equipment.

Cranes are used in factories, warehouses, and shipyards to provide lifting and movement of heavy objects within the area covered by the crane's area of operation. Cranes are machines used to lift and move heavy loads. Because of their great power and the potential for accidents, cranes can be the most dangerous piece of equipment at a worksite.

There are three primary types of cranes used in industrial settings:
1. Bridge Cranes:
   Bridge cranes are mounted on parallel rails attached to elevated wall structures. The bridge is the beam that runs between the two rails. A trolly with a hoist mechanism travels back and forth on the bridge. A key limitation of this system is that the requirement for the beam limits multiple cranes from operating in the same area and also the beam can not operate where there might be obstacles near the ceiling.
2. Gantry Cranes:
   Gantry cranes have a bridge supported by two legs that move along floor-mounted rails or on wheels. As with the bridge crane, a trolley runs back and forth on the bridge. A key disadvantage of this is that it needs to be rolled on the ground and thus takes a lot of space and takes a lot of floor space as well.
3. Jib Cranes
   Jib cranes have a jib or a boom that is mounted to a wall or a mast. The jib crane swings in an arc around its pivot and the trolley runs from end to end on the jib. This has a limited area of use and the manner of movement of the jib is severely limited to the arc around the wall and also this can not reach any corners.

Also, a key limitation of all of the above is that it is not possible to have multiple such cranes running simultaneously covering all of the site space. Generally, only one such system can be employed at a unit in the same space and the same crane has to each time travel to carry a load from one place to another. The units where multiple conventional crane systems are used have a limitation over the space they can travel and hence one such crane system cannot travel the whole area. Hence, such equipment are not that efficient.

Industrial overhead cranes have controllers that give the operator control of all of the crane movements: bridge travel, trolley travel, and hoist raise and lower. The controller will either be a pendant control hard-wired to the crane structure which requires the operator to walk with the load as it travels along the bridge; or a wireless radio control or both.

Patent application DE102016120115A1 relates to an overhead crane with a horizontally extending crane girder, which is trajectory traversable along a crane track, and with a crane trolley, which is movable along the crane girder and carries a hoist for lifting and lowering a load, wherein the overhead crane electric drives for movements of running crane but this invention has some limitations such as only one crane is allowed in one work area or more than one also but needed lots of area and two cranes cannot cross each other so the delivery area is limited for more cranes as well on fixed rails and if any maintenance needed the whole plant stops due to non-availability of material.

Patent application U.S. Pat. No. 8,628,289B1 relates to a system and method for optimizing the storage capacity of an automated material handling and storage system wherein rows of vertical columns of storage bins are spaced in opposing relationship with one another such that at least one elevator is vertically movable in engagement with the opposing columns of storage bins so that pallets, support platforms or containers may be transferred to or from the elevator to bins of the opposing rows and wherein the elevator may be selectively elevated by overhead carriers that are movable along an intersecting grid track system that is disposed above the storage bins. In one of embodiment, the at least one elevator may be independently vertically movable between the opposing column of storage bins. However, this invention has material box size limitation for transferring from one place to another place. Hence, it is not applicable for bigger loads.

Therefore, there is a need of improvement in the existing technology used in material handing and storage that helps in rectifying the abovementioned drawbacks. Hence, there is need of an efficient system that allows more than one vehicle to work simultaneously in a work area.

Also, in a multitude of requirements, an object is required to be transported from one point to another in a three dimensional space. Doing so, via a system, especially when the object may be a large or heavy can be cumbersome. Thus, there is a need for a system to achieve this object. A system which achieves this and can be automated would be hugely beneficial. A system which can achieve this while optimizing travel times and allow for multiple such transports to run in parallel while efficiently using the lattice infrastructure would be very efficient and is needed currently.

Thus, there is a need for a smarter load transportation system which can transport loads from one point to another whether on one floor, on one connected room or across different vertical levels or between different points of a lattice structure. The present invention hopes to achieve the same.

### OBJECTIVES OF THE INVENTION

The main object of the present invention is to provide a load transportation system across different points whether on a floor, on one connected room or across different vertical levels or between different points of a lattice structure.

The object of one of the embodiments of the present invention is to provide an efficient overhead crane system for use in material handling and storage processes that allows multiple number of vehicles in work space to operate simultaneously and reduce the work in process (WIP) time for completion and increases productivity.

Yet another object of one of the embodiments of the present invention is to provide a system for material handling and storage processes that efficiently uses ceiling space for material handling vehicles instead of ground level material handling vehicles hence allowing use of ground space for other purposes.

Still another object of one of the embodiments of the present invention is to allow multiple vehicles with cranes to operate simultaneously within the prescribed commands given by programmable PLC controller as per the coordinate system to carry or transport material in any X-Y direction.

### SUMMARY OF THE INVENTION

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

The present invention provides an efficient overhead crane system for material handling and storage that allows more than one overhead vehicles in the work area for simultaneously transferring material in X-Y direction on guided path.

In an embodiment, the present invention provides an efficient overhead crane system for use in automatable material handling and storage comprises of plurality of overhead cranes each supported by a transport vehicle, a guided rails matrix, and a control system wherein the system allows said plurality of overhead cranes supported by transport vehicles mounted over the guide rail matrix to travel in X-Y direction for material handling and storage; said guide rail matrix is supported by roof ceiling using a suitable screwing technique; and one or more transport vehicles transfer material at the same time on the guide rail matrix without collision. Said control system is configured to run the overhead cranes each having a transport vehicle and transport material from one place to another. Said guide rail matrix is such that a plurality of cells are formed and the transport vehicle runs on guide rails surrounding the cells. The control system includes controllers such as but not limited to programmable logic controllers, microcontrollers etc.

In another embodiment, the present invention provides a plurality of overhead crane each having a transport vehicle wherein each overhead crane and transport vehicle are integrated with a microcontroller and a built-in sensing unit to avoid collision between vehicles as well as material carried. The transport vehicle optionally comprises robotic arms or portable machinery to place material appropriately or perform work (like packing, machining, other operations) to produce goods.

Other aspects of the present invention will become apparent to those ordinarily skilled in the art upon review of the following description of specific embodiments of the invention in conjunction with the accompanying drawings.

### BRIEF DESCRIPTION OF THE DRAWINGS

The present invention can be more easily understood and further advantages and uses therefore can be more readily apparent, when considered in view of the detailed description and the following figures;

FIG. 1 illustrates three types of conventional craning systems namely Bridge cranes 101, Gantry cranes 102 and jib cranes 103.

FIG. 2a depicts a Guide rail matrix 201 as part of an embodiment of the present invention.

FIG. 2b depicts an overhead vehicle or a Crane car 202 for load transportation as an embodiment of the present invention.

FIG. 3a shows a perspective view of a car on the rails.

FIG. 3b illustrates an embodiment of the present invention having a car with a single wheel pair 302 in each half and also shows a gap between the rails.

FIG. 3c illustrates an embodiment of the present invention having a car with a single wheel pair in each half along with a central wheel pair 303.

FIG. 3d illustrates an embodiment of the present invention having a car with a single wheel pair in each half along with a connected bottom platform which also has corresponding wheel pairs.

FIG. 3e illustrates the mechanism by which an overhead vehicle or a Crane Car crosses a gap in the Guide rail matrix as part of an embodiment of the present invention having a connected bottom platform which also has wheel pairs.

FIG. 4a illustrates the mechanism by which an overhead vehicle or a Crane Car turns direction with respect to the Guide rail matrix as part of an embodiment of the present invention.

FIG. 4b illustrates the jack system which enables the Crane Car to turn its direction perpendicularly with respect to the Guide rail matrix as part of an embodiment of the present invention.

FIG. 4c illustrates a transparent view of a car showing the jack system mentioned in FIG. 4b.

FIG. 4c illustrates a transparent view of a car with a connected bottom platform showing the jack system mentioned in FIG. 4b.

FIG. 5 illustrates another embodiment of the present invention involving a lift apparatus for transportation of loads across multiple floors vertically.

FIG. 6 illustrates the buffer space present in an embodiment based on the one shown in FIG. 5 which allows for stacking of multiple lift apparatus.

FIGS. 7a and 7b illustrate the car and lift trolley present in two different loading positions in an embodiment based on the one shown in FIG. 5.

FIGS. 8a and 8b illustrate the lift locking mechanism present in the embodiment shown in FIG. 5 involving a lift apparatus for transportation of loads across multiple floors vertically.

FIG. 9 shows how in an embodiment of the present invention, a load can be transported from Point A to Point B on a 3d lattice and one of the paths that the car can take for such transportation.

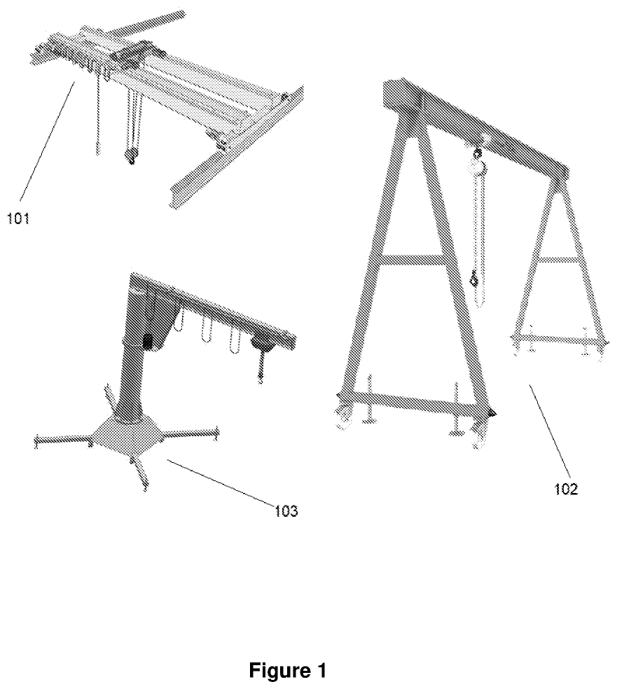

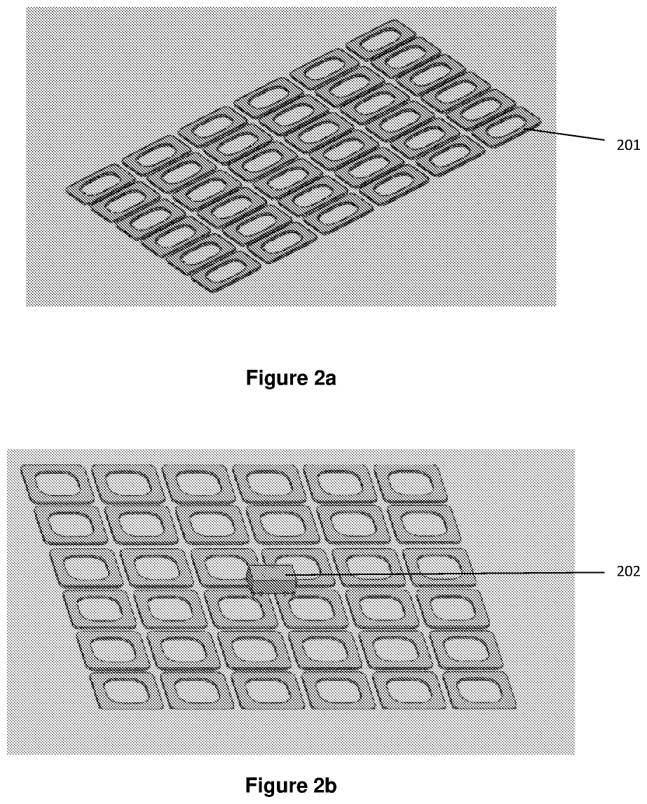

### DETAILED DESCRIPTION OF THE INVENTION

In the following detailed description, reference is made to the accompanying drawings that form a part hereof, and in which is shown by way of illustration specific illustrative embodiments in which the product may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

The present invention relates to load transportation systems and more particularly overhead crane systems.

One of the embodiments of the present invention involves automatable overhead vehicles or cars for material handling that allows cranes attached at bottom of the said vehicles to pick-up a load and the automatable vehicles can then travel over a guided path for transferring the load from one place to other along the path provided on the overhead rails supported by roof ceiling. The overhead rails may be connected to the roof ceiling via screwing method. In this embodiment, within a single workspace, one or more vehicles can transfer loads at the same time on a guided path in any X-Y direction while being controlled by PLC controller based on coordinate system to avoid collision and also to control vehicles speed.

Another embodiment of the present invention provides an efficient overhead crane system for use in automatable material handling and storage comprising of a plurality of overhead cranes each supported by a transport vehicle 202, a guided rail matrix 201, and a control system wherein the system allows said plurality of overhead cranes supported by transport vehicles mounted over the guide rail matrix to travel in X-Y direction for material handling and storage; said guide rail matrix is supported by roof ceiling using a suitable screwing technique; and one or more transport vehicles transfer loads at the same time on the guide rail matrix without collision. Said control system is configured to run the overhead cranes each having a transport vehicle and transport material from one place to another. Said guide rail matrix is such that a plurality of cells are formed and the transport vehicle runs on guide rails surrounding the cells. The control system includes controllers such as but not limited to programmable logic controllers (PLC), microcontrollers etc.

In another embodiment, the present invention provides a plurality of overhead crane cars, each connected to a transport vehicle wherein each overhead crane and transport vehicle are integrated with a microcontroller and a built-in sensing unit to avoid collision between vehicles as well as material carried. The transport vehicle optionally comprises robotic arms or portable machinery to place material appropriately or perform work (like packing, machining, other operations) to produce goods. The transport vehicle is preferably a rectangular vehicle with wheels to run on the guide rails and the number of vehicles are preferably eight or ten. The outer wheels of the vehicle are retractable and the vehicle rotates to move from X to Y direction. The sensing unit includes a plurality of sensors including but not limited to proximity sensors, position sensors, optical sensors for distance measurement. Said sensors help in eliminating limitation regarding the size of load carried by the crane.

The said guided rail matrices may be supported by roof ceiling using a suitable screwing technique. The said guide rail matrix is such that a plurality of cells are formed and the transport vehicle runs on guide rails surrounding the cells.

One of the embodiments of the present invention involves:
1. A disconnected grid matrix 201 attached to the current level's ceiling.
2. Cranes connected to travel cars 202 running on this matrix along the various internal edges of the grid 201
3. The Crane cars are capable of crossing gaps between adjacent edges while travelling in straight direction which is also being described below.
4. The Crane cars are capable of changing direction perpendicularly via the Mechanism for turning which is being described below.

Mechanism for Crossing Gaps:

In case the car 202 has to move straight ahead and cross the gap from one edge to a parallel edge straight in front of the current edge but across a gap 301, it can cross the gap simply by moving forward.

In a normal car with one wheel pair 302 in each half, the car can not cross any gap without falling or tilting and getting stuck since the moment the front wheel loses contact with the rails, the car will tilt due to unbalanced weight force.

In an embodiment of the present invention, we can enable this car to cross gaps by having a center wheel 303 vertically aligned with the center of gravity of the car. This would enable this car to cross gaps up to the distance between the centers of the front wheel and the center wheel. This is because while the front wheel is in air the center wheel will balance the weight of the car until the front wheel comes into contact with the next rail. In case the car is uniformly weighted or the load is uniformly distributed such that the center of gravity of the car is along the middle of the car, then the center wheel will also be at the center of the car. In this embodiment, we can further improve the stability and smoothness of the car by having extra pairs of wheels on each side of the center of the car.

In one of the embodiments of the present invention, we have the car connected to an additional bottom platform 304 below the rail with the said bottom platform also having one or more wheel pairs to help the car in crossing gaps. The car is connected to the bottom platform via a connecting rod which passes through the lateral gap between the two rails on which the wheel pairs of the car are placed on. We can allow this car to cross much larger gaps by keeping the bottom platform wheel pair 305, which is closest to the back of the bottom platform, nearer to the back of the bottom platform as compared to the distance between the upper car wheel pair 306, nearest to the back of the upper car, and the back of the upper car. This would allow balancing of the forces and torques while the car is crossing the gap.

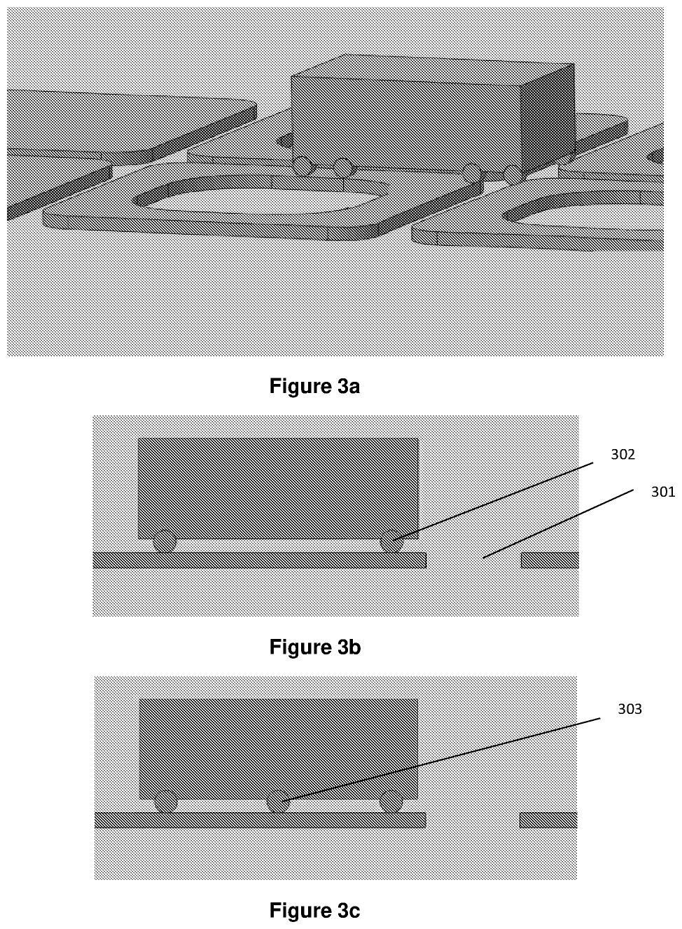

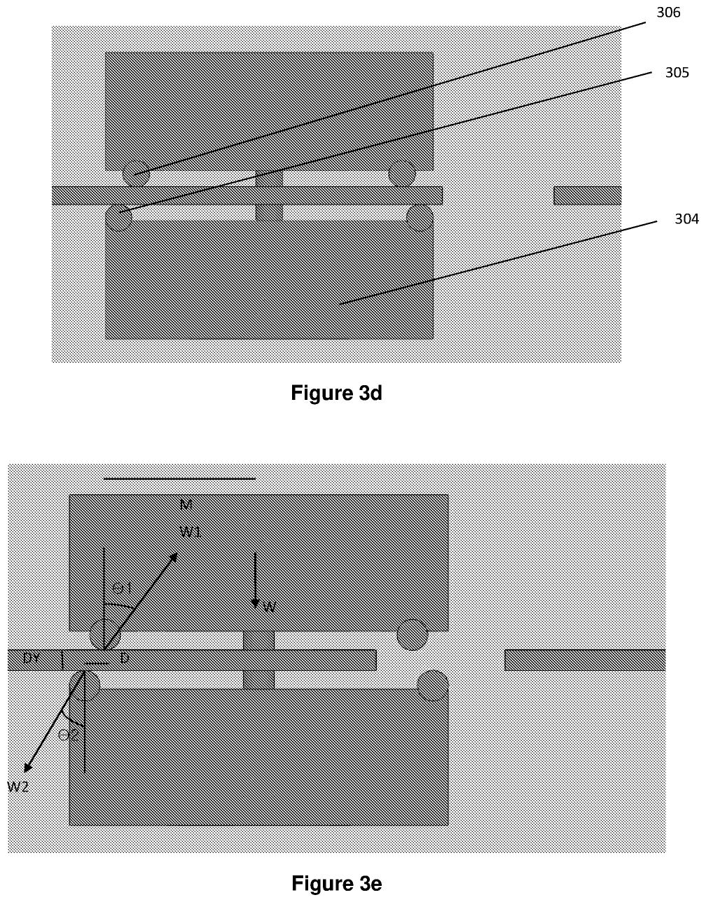

This is further illustrated in FIG. 3e.

Balancing the vertical forces on the car gives the equation:

W+W2 Cos(Θ2)=W1 Cos(Θ1) =>Equation 1

Balancing the horizontal forces on the car gives the equation:

W2 Sin(Θ2)=W1 Sin(Θ1) =>Equation 2

Balancing the Torque on the top wheel of the car gives the equation:

(W2 Cos(Θ2)×DX)+(W2 Sin(Θ2)×DY)=W×M =>Equation 3

Balancing the Torque on the bottom wheel of the car gives the equation:

(W1 Cos(Θ1)×DX)+(W1 Sin(Θ1)×DY)=W×M =>Equation 4

Thus, the bottom wheel is able to provide balance to the car while its front half wheel pairs are in the air as the car is crossing the gap.

Thus, the addition of the bottom compartment to the car along with a bottom platform wheel pair 305 which is slightly nearer to back of the bottom as compared to the distance between the upper car wheel pair 306, nearest to the back of the upper car, and the back of the upper car allows the car to cross much larger gaps.

This mechanism while crossing the larger sized gaps could face some skidding but this can be alleviated by having dynamic suspension systems on top of both the wheels. Also, this mechanism can give further smoothness by having additional wheel pairs in each half of the car.

Mechanism for Turning Direction Perpendicularly:

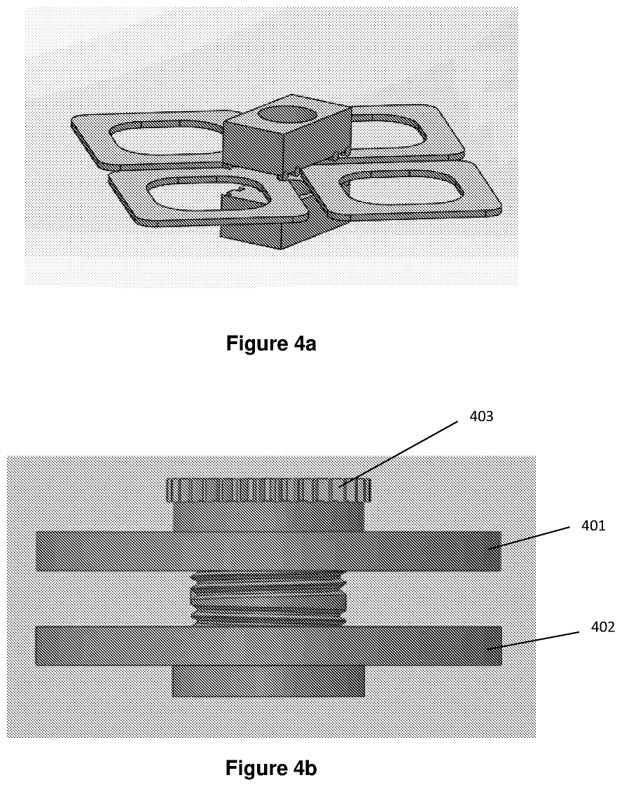

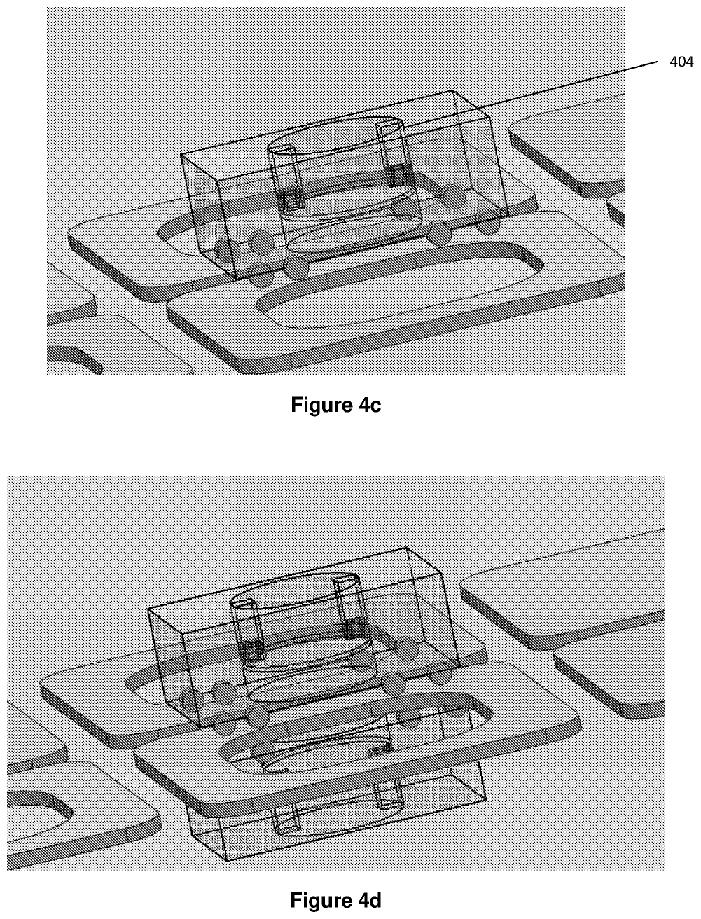

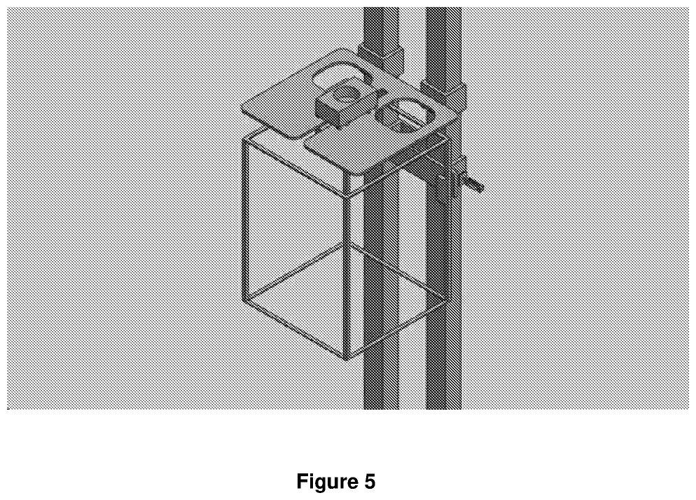

The mechanism by which a Transport car turns its direction perpendicularly to the rail matrix is illustrated in FIG. 4a.

In one of the embodiments of the present invention, the Crane cars would internally comprise a Jack which would have an Upper Jack portion 401, which is above the top of the car, and a Lower Jack portion 402, which is below the bottom of the car, connected via a double screw 403 or one or more pneumatic or hydraulic cylinders 404 which enable the two Jack portions 401, 402 to approach each other such that at some point the Upper Jack portion 401 touches the top of the rail 201 while the Lower Jack portion 402 touches the bottom of the rail 201 and both these jack portions are able to support the weight of the car 202 and its load and thus enable the car to be able to rotate with respect to the rail matrix 201. Thereafter, the car rotates in either perpendicular direction to an edge of the rail matrix 201 that it is currently on, and once in position after rotation the screw 403 is unscrewed and the two Jack portions 401, 402 move away so that the Car 202 again is lifting its and its load's weight directly and can now move along the new edge of the rail matrix 201 that it is placed upon. This way the car is able to perform a turn at any crossing in the rail matrix. This is also illustrated in FIG. 4b.

FIG. 4c illustrates a transparent view of a car showing the jack system mentioned in FIG. 4b.

FIG. 4c illustrates a transparent view of a car with a connected bottom platform showing the jack system mentioned in FIG. 4b.

Essentially, the turning of direction of a Crane car 201 while operating on the Guide rail matrix 202 is achieved via a jack system inbuilt in the car wherein at the corner of the block where the turn needs to be made, the jack system lowers until it touches the rails and is able to shoulder the weight of the car, such that then the car is free to rotate around the axis formed by such jack system at the corner of the rail. Once the car has rotated perpendicularly in the new direction needed and the same could be programmed or detected via sensors, the jack system can be unscrewed such that it loses contact with the rails and no longer needs to support the wright of the car and the car is then free to move along the rail in the new turned direction.

When the shaft turns the plates move towards the support plates, grip the support plates and lift the car and the underslung load. Once the car is lifted and plates held then motor turns further causing rotation between the car and the fixed jack and turn plates causing the whole car to turn when the screw rotates. Hence the turning motion of the car is realized with only one motor and actuator. Once the turn is executed in the appropriate position as commanded by the controller and checked by sensors then a brake is applied between the car and support plates. This causes the support plate to loosen and retract into the car. This enables the whole turn movement to be executed by a single motor.

Embodiment enabling three-dimensional transportation:

In another embodiment of the present invention, three-dimensional transportation is enabled by connecting a plurality of levels with one guide rail matrix on each level along with a suitable lifting mechanism for lifting the transport car with load across different levels or floors vertically. Thus, for multi-level transportation, vertical transportation is achieved between levels via a special lift apparatus 601 which would be described in greater detail below while the horizontal movement is done in a manner similar as described in previous embodiment on the same level. In such embodiments, the load can be in the form of passengers as well.

FIG. 5 illustrates an embodiment of the lift apparatus depicting the lift shaft, lift trolley.

The lift apparatus operates by having the car which may or may not be carrying the load, to load on to or to attach to the lift trolley and then the lift trolley moving along the lift shaft vertically to the desired level where the car unloads or detaches itself from the lift trolley and is thereafter free to travel along the guided rail matrix at the new level.

Furthermore, in another embodiment of the present invention, multiple such lift trolleys can operate simultaneously across the lift shaft without issues, due to the provision of buffer spaces in the lift shaft above the top level and below the bottom level.

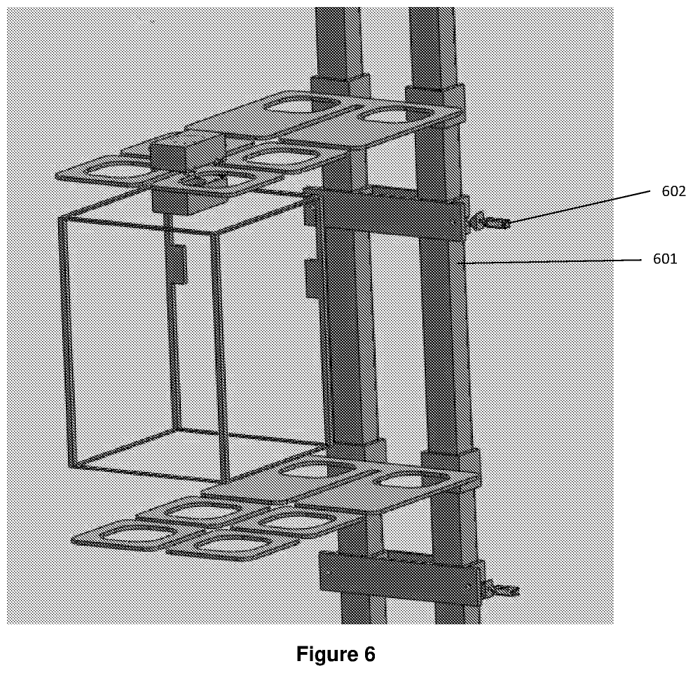

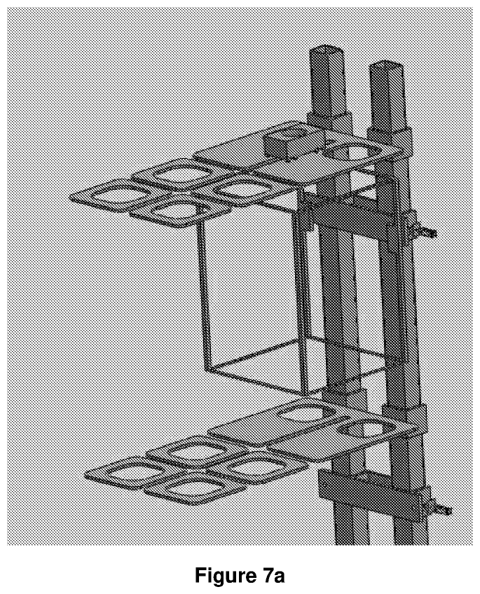

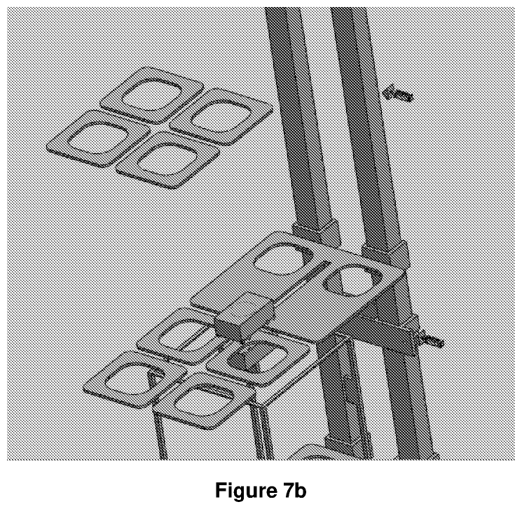

FIG. 6 illustrates how buffer space can be provided at the ends of the lift shaft so that multiple lift trolleys can stack and operate together.

The lift trolleys may move vertically along the lift shaft via lift holders.

The upward and downward travelling lift holders are designed to be much smaller than the full lift. Multiple lifts can operate in the same shaft. The lift holders which come down can wait in a lower shaft for all the above lift holders to come and then they can all go up one by one to deliver people or goods and then wait similarly in the buffer space above.

Also, the said lift trolleys are equipped with locking mechanisms for securing it in the proper position for the loading or unloading level and another mechanism for securing the car and its load to itself during the period of vertical travel along the lift shaft.

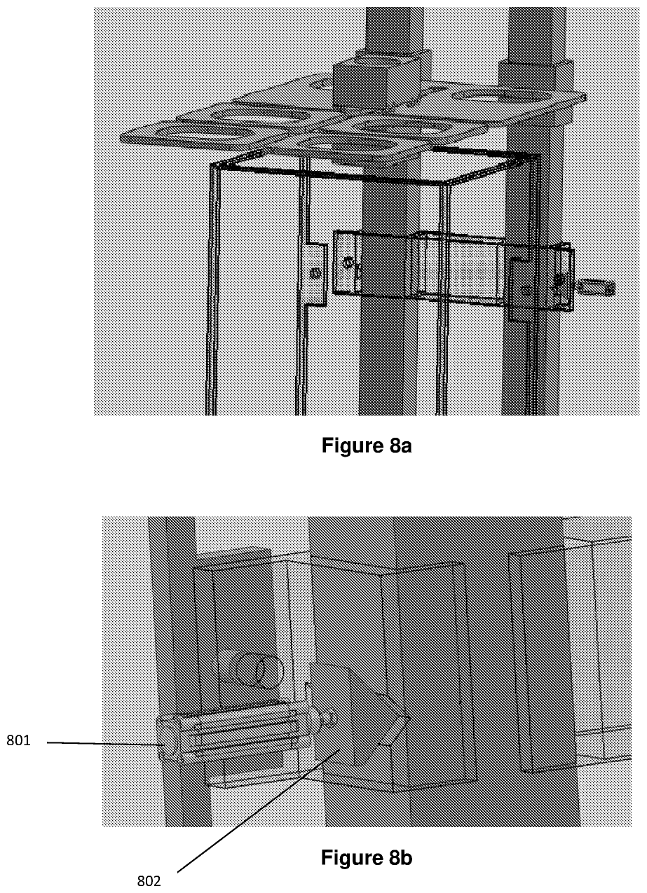

FIGS. 8a and 8b depict the lift locking mechanism present in an embodiment of the present invention.

This locking mechanism is designed to lock the lift into the correct position to allow the car to safely travel to and from the lift. The same lift and lock mechanism above is used to lock the car into the lift trolley wherein two location pins with or without actuated gripping is used to additionally lock the car to the lift trolley for safety and location accuracy.

Another embodiment of the present invention involves Pins having been placed in the car compartment to allow a secure attachment to the lift. These pins may have spring/ball or magnetic mechanism to attach the car to the lift. This is in addition to the car being locked via locking mechanism as mentioned above for balance and stability.

Another embodiment of the present invention involves Wedge lock on both sides of the lift for locking of the car to the lift trolley on both sides of the lift.

In another embodiment of the present invention, any load can be transported from any point A to any point B in a Box structure and thus allowing convenient mechanized full transportability of items across the entire lattice of the structure.

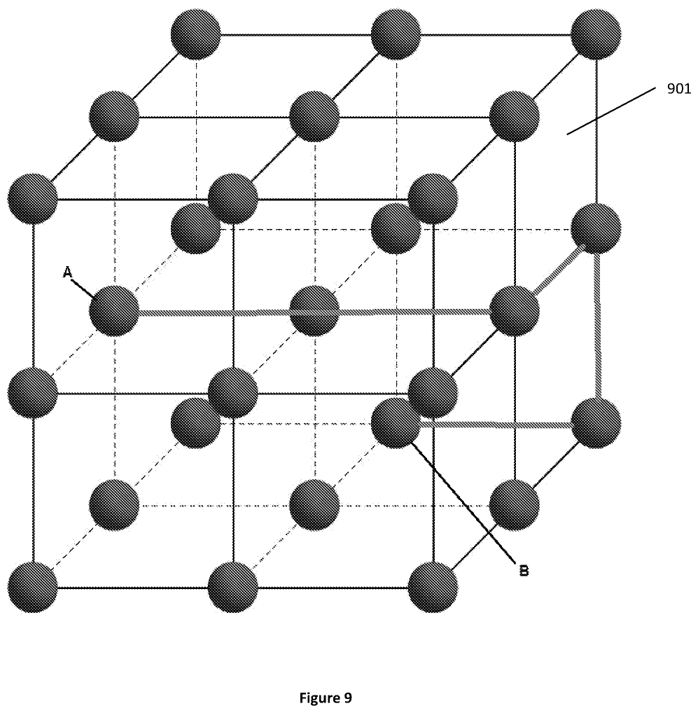

FIG. 9 shows this embodiment of the present invention, wherein a load can be transported from Point A to Point B on a 3d lattice and one of the paths that the car can take for such transportation.

In another embodiment, the present invention provides a plurality of overhead cranes, each having a transport vehicle wherein each overhead crane and transport vehicle are integrated with a microcontroller and a built-in sensing unit to avoid collision between vehicles as well as material carried. The transport vehicle optionally comprises robotic arms or portable machinery to place material appropriately or perform work (like packing, machining, other operations) to produce goods.

In another embodiment of the present invention, multiple cars can collaborate to simultaneously lift the same load while moving in a synchronized manner, with a view to enhance the load carrying capacity and to safely carry oversized load. This is not possible with current overhead lifting systems.

Therefore, the present invention provides a novel technology for material handling and storage that enables more than one automatable vehicle to run in single workspace without any possibility of collision. Hence, the invention overcomes the drawbacks with conventional technology and increases the pace of production. The invention is applicable everywhere in industry involving manufacturing units and storage of goods.

It will be appreciated that variations of the above disclosed and other features and functions, or alternatives thereof, may be desirably combined into many other different products or applications. Also, that various presently unforeseen or unanticipated alternatives, modifications, variations or improvements therein may be subsequently made by those skilled in the art which are also intended to be encompassed by scope of the hereinafter appended claims.

I/We claim:

1. A system for transportation of objects comprising:
One or more matrices of rails 201;
One or more Transport vehicles 202 which can move on the edges of the said matrices of rails;
Wherein said Transport vehicles are capable of carrying loads.

2. The system as claimed in claim 1, wherein the said matrices of rails 201 are supported by the corresponding roof ceiling of their floor via any securing mechanism.

3. The system as claimed in claim 1, wherein the said matrix of rails 201 has a gap 301 between adjacent rails and the said Transport vehicles have a central wheel pair 303 along with one or more wheel pairs in each half of the vehicle.

4. The system as claimed in claim 1, wherein the said matrix of rails 201 has a gap 301 between adjacent rails and the said Transport vehicles each have a connected bottom platform 304 below the rail, connected to the said Transport vehicles via a connecting rod passing through the lateral gap between the two rails on which the wheel pairs of the car are placed on, with the said bottom platform also having one or more wheel pairs placed on the rails from below.

5. The system as claimed in claim 4, wherein the bottom platform wheel pair 305, which is closest to the back of the bottom platform, is nearer to the back of the bottom platform as compared to the distance between the upper car wheel pair 306, nearest to the back of the upper car, and the back of the upper car.

6. The system as claimed in claim 1, wherein the said Transport cars 202 can turn their direction perpendicularly with respect to the said matrix of rails.

7. The system as claimed in claim 1, wherein the said Transport cars 202 have a jack system comprising an Upper Jack portion 401, which is above the top of the car, and a Lower Jack portion 402, which is below the bottom of the car, connected via a double screw 403 or one or more pneumatic or hydraulic cylinders 404 which enable the two Jack portions 401, 402 to approach each other such that at some point the Upper Jack portion 401 touches the top of the rail 201 while the Lower Jack portion 402 touches the bottom of the rail 201 and both these jack portions are able to support the weight of the car 202 and its load and thus enable the car to be able to rotate with respect to the said rail matrix 201.

8. The system as claimed in claim 1, wherein the said matrices of rails have each matrix at different vertical levels and these levels are connected with a lift apparatus 601 which enables transportation across levels.

9. The system as claimed in claim 7, wherein the lift apparatus comprises of a lift shaft, a lift trolley which can move vertically along the said lift shaft, a lift platform connected to the said lift trolley which can connect the said lift trolley with the said matrix of rails at each level such that when the lift trolley is in position at a level, the said Transport car can travel between the matrix of rails on that level and the lift platform of the lift trolley and thereafter while the said Transport car is on the lift platform it can move along with the lift trolley in vertical direction along the lift shaft and thereafter when the lift trolley is in position at any level the said Transport car can then travel from the said lift platform to the matrix of rails at this level.

10. The system as claimed in claim 7, wherein the lift shaft has buffer space so that multiple lift trolleys can stack and operate in the same lift shaft together.

11. The system as claimed in claim 8, wherein the lift trolleys move vertically along the lift shaft via lift holders and the said lift holders are smaller in size than the lift trolleys such that the lift holders can stack and wait in the buffer space when needed to allow multiple lifts to operate in the same lift shaft.

12. The system as claimed in claim 8, wherein the lift trolleys are equipped with locking mechanisms for securing it in the proper position at each level and also locking mechanisms to secure the transport car and its load to itself.

13. The system as claimed in claim 8, wherein location pins with or without actuated gripping are placed on the transport car to allow a secure attachment to the lift trolley.

14. The system as claimed in claim 8, wherein pins with spring ball or magnetic mechanism are placed on the load box compartment to allow a secure attachment to the lift trolley.

15. The system as claimed in claim 8, wherein there are wedge locks on both sides of the lift trolley for locking of the car to the lift trolley on both sides.

16. The system as claimed in claim 6, wherein the system allows for movement from any point A to any Point B across a three-dimensional area and thus allowing full transportability of items across the entire area.

17. The system as claimed in claim 1, wherein the said transport cars can have automatable travel and can be controlled electronically via wireless signals.

18. The system as claimed in claim 15, wherein there the control system operating the movement of the cars is equipped with a collision avoidance mechanism to ensure that no transport cars collide with each other during their movement on the matrices of rails.
